(19) United States
(12) Patent Application Publication
(10) Pub. No.: US 2005/0278401 A1
(43) Pub. Date: Dec. 15, 2005

(54) Apparatus and method for motion vector search and post filtering with reduced hardware resources

(75) Inventor: Yoichi Katayama, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kanagawa (JP)

(21) Appl. No.: 11/148,177

(22) Filed: Jun. 9, 2005

(30) Foreign Application Priority Data
Jun. 10, 2004 (JP) 172735/2004

(51) Int. Cl. G06F 7/00

(52) U.S. Cl. 708/203

(57) ABSTRACT

An image processing circuit is composed of: a plurality of registers retaining pixel data, respectively; a plurality of absolute difference calculator/adders; at least one selective multiplier, each disposed between associated one of said registers and associated one of said absolute difference calculator/adders; and an adder calculating a sum of outputs of said absolute difference calculator/adders. Each of said at least one selective multiplier is designed to perform selected one of first and second operations; said first operation involving transferring pixel data retained in said associated one of said registers as it is to said associated one of said absolute difference calculator/adders, and said second operation outputting a product of a predetermined coefficient and said pixel data retained in said associated one of said registers onto an input of said associated one of said absolute difference calculator/adders. Each of said absolute difference calculator/adders is designed to perform selected one of absolute difference calculation and adding operation, said absolute difference calculation involving calculating an absolute difference of pixel data inputted thereto, and said adding operation involving calculating a sum of said pixel data inputted thereto.

### BACKGROUND OF THE INVENTION

1. Field of the Invention

The present invention relates to image processing circuits, more particularly to image processing circuits for video compression and decompression.

2. Description of the Related Art

As known in the art, the video compression and decompression generally involve various image data processing techniques. For example, the video compression and decompression in accordance with the ITU-T Recommendation H.261 involves DCT (Discrete Cosine Transform), quantization, inverse quantization, inverse DCT, and motion compensation, as disclosed in Hiroshi Fujiwara et al. “Point-illustrated MPEG text” 1st version, ASCII publication, issued on Aug. 1, 1994, p.p. 74-75. The video compression and decompression in accordance with the MPEG (moving picture expert group) standards involve variable length coding in addition to the above-described image data processing techniques.

The motion vector search is one of the important processes for video compression. The motion vector designates a vector used for the motion compensation, indicating of the movement of a specific region of an image between adjacent frames. For the video compression according to the MPEG standard, the motion vector search is performed for each block, which is constituted with 16×16 pixels.

Referring to FIG. 1, the motion vector search for a certain block is typically performed through calculation of SAD (Sum of Absolute Difference) for each vector within a predetermined search range. The SAD is a sum of absolute values of the differences between pixel data of pixels within an input block and pixel data of the corresponding pixels of a reference block with respect to the entire of the input block; the input block designates a target block within the input image, for which the SAD is to be calculated, and the reference block is a block within the reference image used for calculate the SAD. For example, the SAD for the vector V (mvx, mvy) of a certain input block is calculated by the following equation (1):

$$SAD {\vert}_{V = ( mvx , mvy )} = {\sum }_{i , j} \vert A ( i , j ) - B ( i + mvx , j + mvy ) \vert , \qquad ( 1 )$$

where A (i, j) denotes pixel data of a pixel located at coordinates (i, j) within the input image, and B (i′, j′) denotes pixel data of a pixel located at coordinates (i′, j′) of the reference image. It should be noted that the symbol “Ε” means a sum for all of the pixels within the input block. For example, the SAD of the vector (1, 0) is obtained by the following equation (1′):

$$SAD {\vert}_{V = ( 1 , 0 )} = {\sum }_{i = 0}^{15} {\sum }_{j = 0}^{15} \vert A ( i , j ) - B ( i + 1 , j ) \vert , \qquad ( {1}^{′} )$$

where coordinates of the left top of the relevant input block are (0, 0), and coordinates of the right bottom are (15, 15). A motion vector of the input block is determined as a vector V which minimizes the SAD calculated by the equation (1).

The post filtering is another image processing technique for improving the image quality of the decompressed image. The post filtering addresses reduction of block distortion. A decompressed moving image often exhibits discontinuous change at boundaries of blocks, due to the fact that the image processing procedures are performed in units of blocks. Such discontinuous change, referred to as the block distortion, is one of the major causes of image quality degradation. The post filtering improves smoothness of the image at the boundaries of the blocks, and effectively improves image quality of the moving image.

The post filtering is performed through calculating a weighted average of pixel data with respect to a target pixel and the neighboring pixels. FIG. 2 illustrates an exemplary procedure of post filtering in a horizontal direction. Pixel data C′ (x, y) of a target pixel after the post filtering in the horizontal direction is typically calculated by the following equation (2):

$${C}^{′} ( x , y ) = {\sum }_{i = x - m}^{x + n} \frac{{c}_{i} \cdot C ( i , y )}{{\sum }_{i = x - m}^{x + n} {c}_{i}} \qquad ( 2 )$$

where C (i, j) is the pixel data of a pixel positioned at coordinates (i, j) before the post filtering, and cᵢ is a weighting coefficient. The weighting coefficient cᵢ is defined so that the weighting coefficient cᵢ is increased as the difference from x is decreased. The post filtering in accordance with the equation (2), based on pixel data of a series of (m+n+1) pixels, is often referred to as (m+n+1)-tap post filtering. The 9-tap post filtering, for example, is achieved on the basis of the following equation (2′):

$${C}^{′} ( x , y ) = \{ C ( x - 4 , y ) + 2 C ( x - 3 , y ) + 4 C ( x - 2 , y ) + 8 C ( x - 1 , y ) + 16 C ( x , y ) + 8 C ( x + 1 , y ) + 4 C ( x + 2 , y ) + 2 C ( x + 3 , y ) + C ( x + 4 , y ) / 46. \qquad ( {2}^{′} )$$

The post filtering in the horizontal direction is performed in a similar manner.

One problem in performing motion vector search and post filtering is that these processing procedures require increased hardware resources. It is said that the motion vector search accounts for 30-40% of recent video codec hardware resources, the post filtering accounts for 10-20% of the codec hardware resources.

Therefore, there is a need for reducing hardware resources required for performing the motion vector search and the post filtering.

### SUMMARY OF THE INVENTION

In an aspect of the present invention, an image processing circuit is composed of: a plurality of registers retaining pixel data, respectively; a plurality of absolute difference calculator/adders; at least one selective multiplier, each disposed between associated one of the registers and associated one of the absolute difference calculator/adders; and an adder calculating a sum of outputs of the absolute difference calculator/adders. Each of the at least one selective multiplier is designed to perform selected one of first and second operations; the first operation involving transferring pixel data retained in the associated one of the registers as it is to the associated one of the absolute difference calculator/adders, and the second operation outputting a product of a predetermined coefficient and the pixel data retained in the associated one of the registers onto an input of the associated one of the absolute difference calculator/adders, and

wherein each of the absolute difference calculator/adders is designed to perform selected one of absolute difference calculation and adding operation, the absolute difference calculation involving calculating an absolute difference of pixel data inputted thereto, and the adding operation involving calculating a sum of the pixel data inputted thereto.

The image processing circuit architecture above-described is design to perform the major processes of the motion vector search and the post filtering by using common hardware resources, achieving reduction in the hardware resources required for the motion vector search and the post filtering.

### BRIEF DESCRIPTION OF THE DRAWINGS

The above and other advantages and features of the present invention will be more apparent from the following description taken in conjunction with the accompanied drawings, in which:

FIG. 1 is a diagram illustrating the motion vector search;

FIG. 2 is a diagram illustrating the post filtering;

FIG. 3 is a block diagram illustrating an exemplary structure of the image processing circuit according to the present invention;

FIG. 4 is a block diagram illustrating an exemplary structure of shifters integrated within the image processing circuit; and

FIG. 5 is a block diagram illustrating another exemplary structure of the image processing circuit according to the present invention.

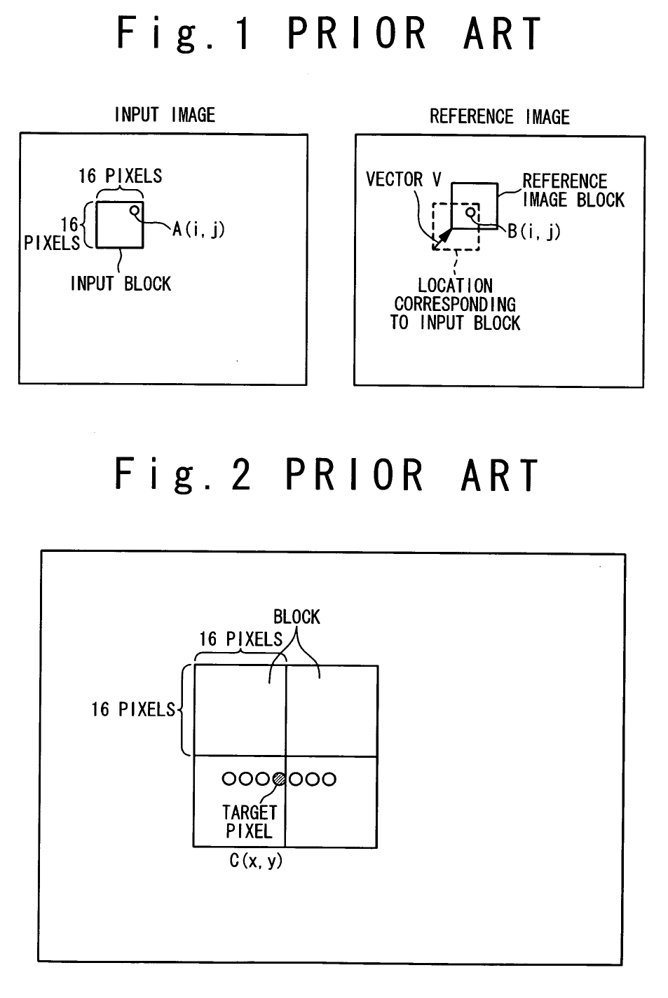

### DESCRIPTION OF THE PREFERRED EMBODIMENTS

The invention will be now described herein with reference to illustrative embodiments. Those skilled in the art would recognize that many alternative embodiments can be accomplished using the teachings of the present invention and that the invention is not limited to the embodiments illustrated for explanatory purposed.

### Image Processing Circuit Structure

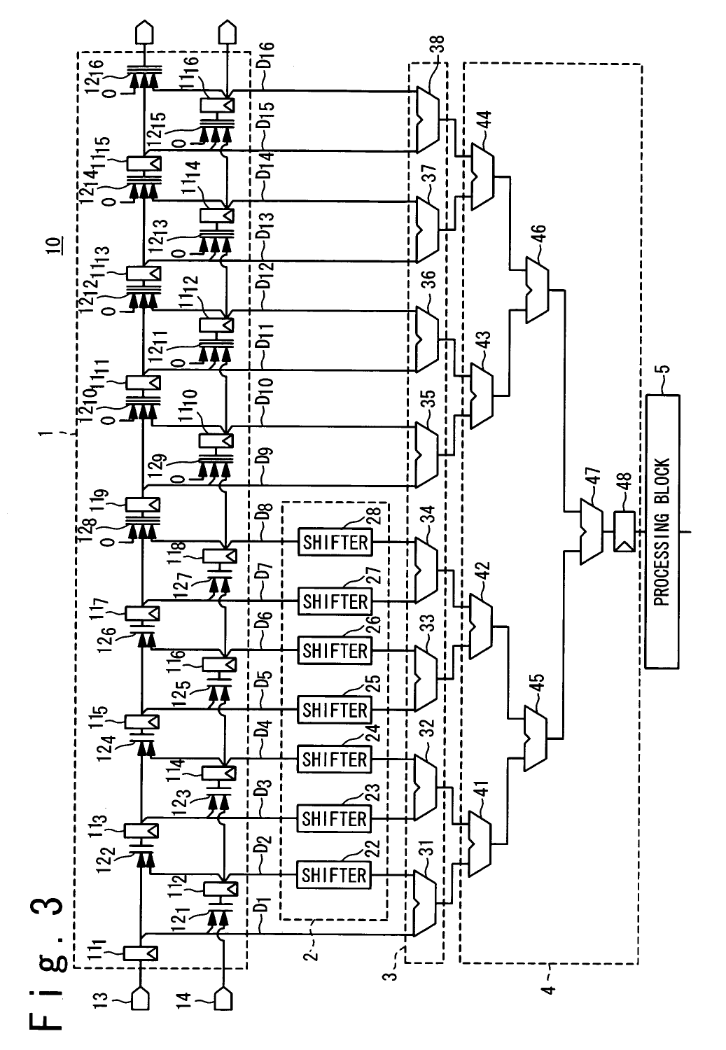

FIG. 3 is a block diagram showing an exemplary structure of an image processing circuit 10 in one embodiment of the present invention. One feature of the image processing circuit 10 is that the image processing circuit 10 is designed to be adapted to both of the motion vector search and the post filtering.

Specifically, the image processing circuit 10 includes a shift register section 1, a multiplier section 2, an absolute difference calculator/adder section 3, an adder section 4, and a processing block 5.

The shift register section 1 includes a set of registers 11₁ to 11₁₆ and a set of selectors 12, to 12₁₆. The shift register section 1 is designed to transfer pixel data provided on a pair of input terminals 13 and 14 to desired ones of the registers 11₁ to 11₁₆. The selectors 12₁ to 12₁₆ are used to switch the path to transfer the pixel data in accordance with the operation mode of the image processing circuit 10. When the motion vector search is performed, the selectors 12₁ to 12₁₆ provide connections among the registers 11₁ to 11₁₆ so that the pixel data serially inputted to the input terminal 13 are sequentially transferred to the odd-numbered registers 11₁, 11₃, . . . , and 11₁₅, and the pixel data serially inputted to the input terminal 14 are sequentially transferred to the even-numbered registers 11₂, 11₄, . . . , and 11₁₅. When the post filtering is performed, on the other hand, the selectors 12₁ to 12₁₆ provide serial connections among the registers 11₁ to 11₁₆ so that the pixel data serially inputted to the input terminal 13 are sequentially transferred to the registers 11₁, 11₂, . . . . The pixel data retained in the register 11₁ to 11₁₆ is referred to as the pixel data D₁ to D₁₆, respectively.

The selectors 12₉ to 12₁₅, connected to the inputs of the register 11₁₀ to 11₁₆, respectively, are designed to receive logical “0” on one input thereof, and to provide logical “0” for the associated registers. Resetting the registers 11₁₀ to 11₁₆ to logical “0” is achieved through providing logical “0” from the selectors 12₉ to 12₁₅ to the registers 11₁₀ to 11₁₆.

The multiplier section 2 includes an array of seven shifters 22 to 28, connected to the register 11₂ to 11₈, respectively. The shifters 22 to 28 respectively receive pixel data D₂ to D₈ from the registers 11₂ to 11₆, and perform left shift operation on the corresponding pixel data D₂ to D₈ in response to a request. It should be noted that the shifters 22 to 28 do not always perform left shift operation. Specifically, when the motion vector search is performed, the shifters 22 to 28 output the received pixel data as they are. When the post filtering is performed, on the other hand, the shifters 22 to 28 perform left shift operation on the associated pixel data.

In detail, the shifters 22 to 28 are designed to operate as follows: the shifters 22 and 28, positioned on the left and right of the shifter array, are designed to perform 1-bit left-shift, and the shifters 23, 27, which are the second ones from the left and right, respectively, are designed to perform 2-bit left-shift. The shifters 24, 26 are designed to perform 3-bit left-shift, and the shifter 25, positioned at the center of the shifter array is designed to perform 4-bit left shift.

It should be noted that performing the n-bit left shift operation on a certain data is equivalent to multiplying the data by a value of 2n. Therefore, the shifter 22 functions as a multiplier designed to output selected one of the pixel data D₂ and the value of the pixel data D₂ multiplied by two. Correspondingly, the shifter 23 functions as a multiplier designed to output selected one of the pixel data D₃ and the value of the pixel data D₃ multiplied by four, and the shifter 24 functions as a multiplier designed to output selected one of the pixel data D₄ and the value of the pixel data D₄ multiplied by eight. In addition, the shifter 25 functions as a multiplier designed to output selected one of the pixel data D₅ and the value of the pixel data D₅ multiplied by sixteen, while the shifter 26 functions as a multiplier designed to output selected one of the pixel data D₆ and the value of the pixel data D₆ multiplied by eight. Finally, the shifter 27 functions as a multiplier designed to output selected one of the pixel data D₇ and the value of the pixel data D₇ multiplied by four, and the shifter 28 functions as a multiplier designed to output selected one of the pixel data D₈ and the value of the pixel data D₈ multiplied by two.

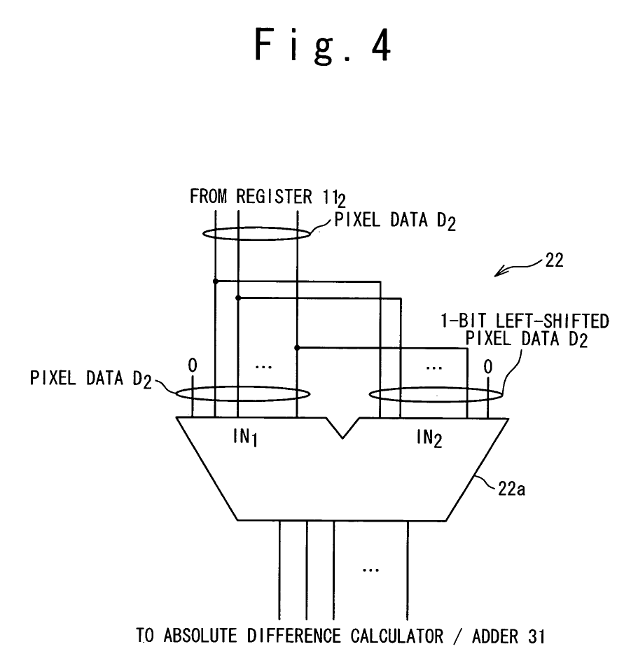

As shown in FIG. 4, the shifter 22 is preferably composed of a multiplexer 22a designed to output selected one of the pixel data D₂ and the value of the pixel data D₂ 1-bit left-shifted. The pixel data D₂ is input onto the first input IN₁ of the multiplexer 22a, and the value of the pixel data D₂ 1-bit left shifted is input onto the second input IN₂. More specifically, the multiplexer 22a receives the pixel data D₂ as the second most to least significant bits of the first input IN₁, respectively, setting the most significant bit of the first input IN₁ to logical “0”. Additionally, the multiplexer 22a receives the pixel data D₂ as the most to second least significant bits of the second input IN₂, setting the least significant bit of the second input IN₂ to logical “0”. When the first input IN₁ is selected, the multiplexer 22a outputs the pixel data D₂ as it is. When the second input IN₂ is selected, on the other hand, the multiplexer 22a outputs the pixel data D₂ 1-bit left-shifted, in other words, the value of the pixel data D₂ multiplied by two. Such architecture of the shifter 22 is preferable for improving the circuit simplicity.

The aforementioned shifter architecture is applicable to the shifters 22 to 28. The shifter 23 may be designed to output selected one of the pixel data D₃ and the value of the pixel data D₃ 2-bit left-shifted, and the shifter 24 may be designed to output selected one of the pixel data D₄ and value of the pixel data D₄ 3-bit left-shifted. The shifter 25 may be designed to output one of the pixel data D₅ and the value of the pixel data D₅ 4-bit left-shifted, and the shifter 26 may be designed to output selected one of the pixel data D₆ and the value of the pixel data D₆ 3-bit left-shifted. Finally, the shifter 27 may be designed to output selected one of the pixel data D₇ and the value of the pixel data D₇ 2-bit left-shifted, whereas the shifter 28 is designed to output selected one of the pixel data D₈ and the pixel data D₈ 1-bit left-shifted.

The absolute difference calculator/adder section 3 is composed of 2-input absolute difference calculator/adder 31 to 38. The absolute difference calculator/adder 31 to 38 are each designed to perform selected one of the absolute difference calculation and the adding operation in response to an externally-inputted control signal. The inputs of the absolute difference calculator/adders 31 to 38 are connected to the outputs of the register 11₁ to 11₁₆ directly or though the shifters 22 to 28. Specifically, the first input of the absolute difference calculator/adder 31 is directly connected to the register 11₁, and the second input is connected to the output of the shifter 22. The absolute difference calculator/adder 31 performs the absolute difference calculation or the adding operation with respect to the pixel data D₁ received from the register 11₁ and the data received from the shifter 22, and outputs the results of the performed operation. It should be noted that the data received from the shifter 22 may be the pixel data D₂ itself, or the pixel data D₂ multiplied by two. The absolute difference calculator/adders 32 to 34 respectively perform the absolute difference calculation or the adding operation with respect to the data received from the shifter 23 and 24, to the data received from the shifter 25 and 26, and to the data received from the shifter 27 and 28, respectively, and outputs the results of the performed operations. Correspondingly, the absolute difference calculator/adders 35 to 38 perform the absolute difference calculation or the adding operation with respect to the associated pair of the data received from the associated two of the registers 11₉ to 11₁₆, and output the results of the performed operations.

The adder section 4 is designed to calculate the sum of outputs of the absolute difference calculator/adders 31 to 38. The adder section 4 is composed of 2-input adders 41 to 47, and a register 48. The inputs of the adder 41 are connected to the outputs of the absolute difference calculator/adders 31 and 32. The inputs of the adder 42 are connected to the outputs of the absolute difference calculator/adders 33 and 34. The inputs of the adder 43 are connected to the outputs of the absolute difference calculator/adders 35 and 36. The inputs of the adder 44 are connected to the outputs of the absolute difference calculator/adders 37 and 38. The inputs of the adder 45 are connected to the outputs of the adders 41 and 42. The inputs of the adder 46 are connected to the outputs of the adders 43 and 44. The inputs of the adder 47 are connected to the outputs of the adders 45 and 46, and finally, the input of the register 48 is connected to the output of the adder 47.

The computer 5 is designed to estimate the desired motion vector on the basis of the output value of the register 48 within the adder section 4 (that is, a sum of the outputs of the absolute difference calculator/adders 31 to 38), and also to calculate the resultant pixel data obtained through the post filtering. As will be described later, the output of the register 48 is a partial sum of the terms of the SAD calculated with respect to a desired input block and a desired reference block, when the motion vector is estimated. The computer 5 calculates the desired SAD on the basis of the values sequentially outputted from the register 48 to estimate the motion vector. When post filtering is performed, on the other hand, the output of the register 48 is a weighted sum of the pixel data of the target pixel and the neighboring pixels. The computer 5 calculates the pixel data of the target pixel after the post filtering from the output value of the register 48.

### Circuit Operation

The main feature of the image processing circuit 10 is that the image processing circuit 10 is adapted to perform the major parts of the operations for implementing both of the motion vector search and the post filtering, through properly setting the operations of the shifters 22 to 28 and the absolute difference calculator/adders 31 to 38. Specifically, when the image processing circuit 10 is place into a motion vector search mode, the shifters 22 to 28 are configured to output the received pixel data as they are, and the absolute difference calculator/adders 31 to 38 are configured to perform the absolute difference calculation. This allows the image processing circuit 10 to calculate the desired SAD, used in the motion vector search. When the image processing circuit 10 is placed into a post filtering mode, on the other hand, the shifters 22 to 28 are configured to output the associated pixel data multiplied by the predetermined coefficients, and the absolute difference calculator/adders 31 to 38 are configured to perform the adding operation. This allows the image processing circuit 10 to calculate the post-filtered pixel data of the target pixel. The thus-described architecture of the image processing circuit 10 enables performing the major parts of the processing operations within both of the motion vector search the post filtering using the common hardware resources, and effectively reduces the necessary hardware resources. Hereinafter, the processes of the motion vector search and the post filtering using the image processing circuit 10 will be described in detail.

(Motion Vector Search)

The motion vector search for a certain input block is performed as follows. In the following description, the coordinates of the right top of the input block are assumed as (0, 0) and the coordinates of the right bottom of the input block are assumed as (15, 15). The pixel data of the pixel located at the coordinates (i, j) is referred to as A (i, j).

The motion vector search begins with selecting a vector from the motion vector search range. The reference block of the reference image is then determined for the input block and the selected vector. When the selected vector V is (1, 0), for example, the coordinates of the right top of the reference block is (1, 0) and the coordinates of the right bottom is (16, 15). The pixel data of the pixel located at the coordinates (i, j) within the reference block is referred to as B (i, j), hereinafter.

The pixel data A(0, 0) to A(7, 0) are then sequentially provided onto the input terminal 13, and the corresponding pixel data of the reference block B (1, 0) to B(8, 0) are sequentially provided onto the input terminal 14. The pixel data A (0, 0) to A (7, 0) are transferred to the odd-numbered registers 11₁, 11₃, 11₅, 11₇ . . . and 11₁₅, respectively. The pixel data B (1, 0) to B (8, 0) associated with of the reference block are transferred to the even-numbered registers 11₂, 11₄, 11₆, 11₈ . . . and 11₁₆, respectively.

The shifters 22 to 28 are configured to transfer the pixel data D₂ to D₈ from the registers 11₂ to 11₈ the absolute difference calculator/adders 31 to 34, whereas the absolute difference calculator/adders 31 to 38 are each configured to calculate the absolute differences of the pixel data received. In other words, the multiplier section 2 and the absolute difference calculator/adder 3 are operated so that the absolute difference calculator/adders 31 to 38 calculate the absolute difference |D₁−D₂|, |D₃−D₄|, |D₅−D₆ . . . and |D₁₅−D₁₆|, respectively. Since Dᵢ is a pixel data retained by register 11ᵢ, the absolute difference calculator/adders 31 to 38 output the absolute differences |A(0, 0)−B(1, 0)|, |A(1, 0)−B(2, 0)| . . . and |A(7, 0)−B(8, 0)|, respectively.

Subsequently, the adder section 4 calculates the sum of the outputs of the absolute difference calculator/adders 31 to 38. This results in that the adder section 4 generates the output data D_{OUT} in accordance with the following equation (3):

$${D}_{OUT} {\vert}_{V = ( 1 , 0 )} = {\sum }_{i = 0}^{7} \vert A ( i , 0 ) - B ( i + 1 , 0 ) \vert . \qquad ( 3 )$$

It should be noted that the output data D_{OUT} defined by the equation (3) is a partial sum of the terms of the desired SAD. The processing block 5 stores the output data D_{OUT} received from the adder section 4.

The similar operations are then performed for the remaining pixels of the input block. The pixel data A(8, 0) to A(15, 0) associated with the input block are then transferred to the odd numbered registers 11₁, 11₃, 11₅, 11₇, . . . , 11₁₅, respectively, and the corresponding pixel data B(9, 0) to B(16, 0) associated with the reference block are transferred to the even-numbered registers 11₂, 11₄, 11₆, 11₈, . . . , 11₁₆, respectively. The absolute difference calculator/adders 31 to 38 then calculate the absolute value |A(8,0)−B(9,0)|, |A(9,0)−B(10,0)|, . . . |A(15, 0)−B(16, 0)|, and the sum of these absolute differences is calculated by the adder section 4.

The processing block 5 calculates the sum of the output data D_{OUT} obtained from the pixel data A (0, 0) to A (7, 0) and the output data D_{OUT} obtained from the pixel data A (8, 0) to A (15, 0), and stores the calculated sum.

The same goes for the remaining pixels. The pixel data of another set of eight pixels within the input block are transferred to the odd-numbered registers 11₁, 11₃, 11₅, 11₇ . . . and 11₁₅, and the corresponding pixel data of the associated eight pixels within the reference block are transferred to the even-numbered registers 11₂m 11₄, 11₆, 11₈, . . . and 11₁₆. Upon transferring the pixel data, the aforementioned operation is performed to generate the output data D_{OUT} on the output of the adder section 4. The aforementioned operations are performed to cover all the pixels within the input block, the output data D_{OUT} obtained from each eight pixels within the input block are accumulated within the processing block 5. The sum of the calculated output data D_{OUT} is the SAD to be obtained.

The SAD is calculated for all the vectors within the motion vector search range on the basis of the same operation. The vector with the minimum SAD is the motion vector to be obtained.

(Post filtering)

The post filtering for the decompressed image is performed as follows. It should be noted that the coordinates of the target pixel is referred to as (x, y), and the pixel data before the post filtering of the pixel located at the coordinates (i, j) is referred to as C (i, j).

The post filtering begins with selecting a target pixel from the block relevant to the post filtering. The target pixel is selected from the pixels located at the boundaries of the relevant block.

Pixel data associated with the target pixel and eight pixels located nearby are sequentially inputted to the input terminal 13, and transferred to the registers 11₁ to 11₉ through the selectors 12₁ to 12₈. For the post filtering in the horizontal direction, the pixel data C (x, y) of the target pixel is transferred to the register 11₅, and the pixel data C (x−1, y), C (x+1, y) associated with the pixels just adjacent to the target pixel are transferred the register 11₄ and register 11₆. The pixel data C (x−2, y), C (x+2, y) associated with the pixels positioned second adjacent to the target pixel in the horizontal direction are transferred to the register 11₃ and 11₇, respectively. Correspondingly, the pixel data C (x−3, y), C (x+3, y) associated with the pixels positioned third adjacent to the target pixel in the horizontal direction are transferred to the register 11₂ and 11₈, respectively. Finally, the pixel data C (x−4, y), C (x+4, y) associated with the pixels positioned fourth adjacent to the target pixel in the horizontal direction are transferred to the register 11₁ and 11₈, respectively.

The remaining registers 11₁₀ to 11₁₆ are provided with logical “0” from the selectors 12₉ to 12₁₅ and reset to logical “0”.

The shifters 22 to 28 are configured to perform left-shift operation on the pixel data D₂ to D₈, received from the registers 11₂ to 11₈, by the predetermined numbers of bit(s), and to provide the pixel data D₂ to D₈ left-shifted for the absolute difference calculator/adders 31 to 34. Additionally, the absolute difference calculator/adders 31 to 38 are configured to calculate the sum of the data received from the associated registers. Specifically, the absolute difference calculator/adders 31 to 35 output D₁+2D₂, 4D₃+8D₄, 16D₅+8D₆, 4D₇+2D₈, and D₉, respectively. This results in that the absolute difference calculator/adders 31 to 35 calculates the values of C(x−4, y)+2C (x−3, y), 4C(x−2, y)+8C(x−1, y), 16C(x, y)+8C(x+1, y), 4C(x+2, y)+2C(x+3, y), C(x+4, y), respectively, as is understood from the fact that Dᵢ is the pixel data retained in the register 11ᵢ. The outputs of the remaining absolute difference calculator/adders 36 to 38 are set to logical “0”, receiving logical “0” from the associated registers 11₁₁ to 11₁₆.

The adder section 4 then calculates the sum of the outputs of the absolute difference calculator/adders 31 to 38 to obtain the output data D_{OUT}. The obtained output data D_{OUT}(x, y) is represented by the following equation (4):

$${D}_{OUT} ( x , y ) = C ( x - 4 , y ) + 2 C ( x - 3 , y ) + 4 C ( x - 2 , y ) + 8 C ( x - 1 , y ) + 16 C ( x , y ) + 8 C ( x + 1 , y ) + 4 C ( x + 2 , y ) + 2 C ( x + 3 , y ) + C ( x + 4 , y ) . \qquad ( 4 )$$

It should be noted that the output data D_{OUT} (x, y) is the weighted sum of the pixel data C(x−4, y) to C(x+4, y), and the equation (4) is equivalent to the above mentioned equation (2′) except for that the terms within the equation (4) are not multiplied by 1/46.

The processing block 5 calculates the pixel data C′ (x, y), which is the pixel data after the post filtering, by dividing the output data D_{OUT}(x, y) by 46, which is equal to the sum of the coefficients of the terms of the equation (4).

Subsequently, the same operations are performed for other desired pixels within the relevant block to complete the post filtering.

### CONCLUSION

In summary, the image processing circuit architecture above-described is design to perform the major processes of the motion vector search and the post filtering by using common hardware resources, achieving reduction in the hardware resources required for the motion vector search and the post filtering.

It is apparent that the present invention is not limited to the above-described embodiments, which may be modified and changed without departing from the scope of the invention.

For example, the structure of the image processing circuit may be appropriately modified in accordance with minor changes in the weighted average calculation performed in the post filtering. When a weighting coefficient used for the calculation of the weighted average is not defined as being a power of 2, for instance, relevant one of the shifters 22 to 28 may be replaced with a multiplier designed to output selected one of the corresponding pixel data and the product of the weighting coefficient and the corresponding pixel data. In an alternative embodiment in which the number of pixel data relevant to the weighted average calculation is modified, the number of shifters (or the multiplier) disposed between the registers 11₁ to 11₁₆ and the absolute difference calculator/adders 31 to 38, and the weighted coefficients configured in the shifters may be modified in accordance with the number of the relevant pixel data.

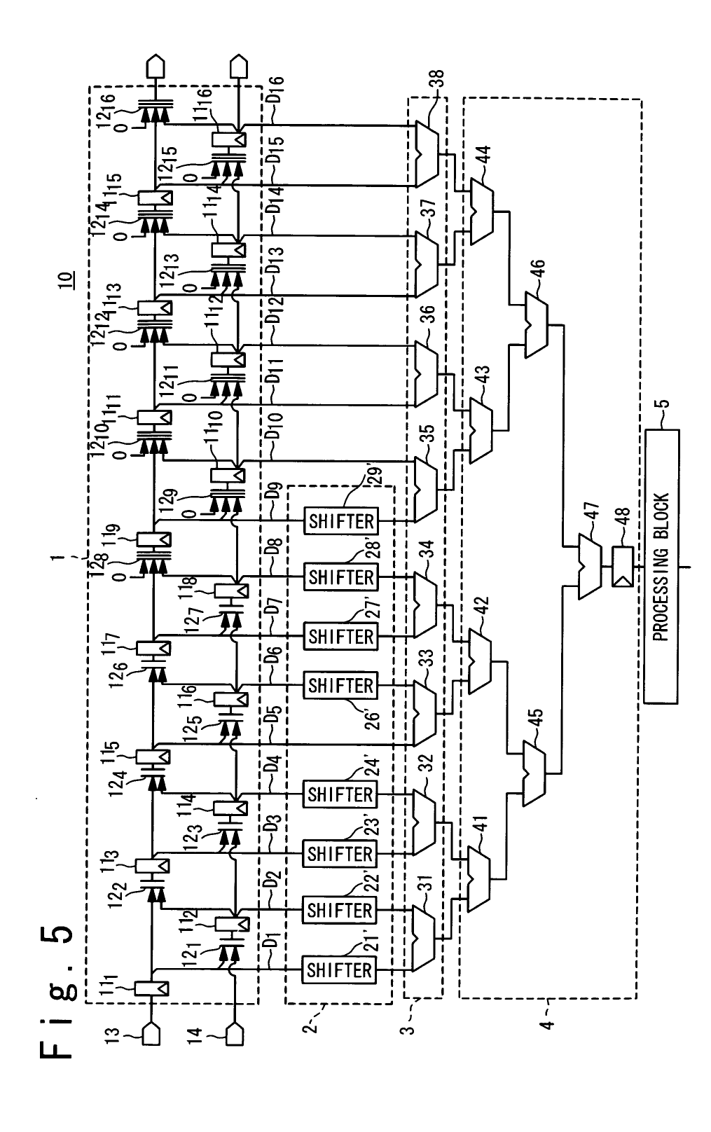

The shifters within the multiplier section 2 may be designed to perform right-shift, instead of left-shift. In still another embodiment, the image processing circuit may be designed as shown in FIG. 5, on the basis of the fact that performing n-bit right-shift on a certain data is equivalent to multiplying the data by 2⁻ⁿ. In the image processing circuit shown in FIG. 5, the multiplier section 2 includes shifters 21′ to 24′ and 26′ to 29′ adapted to perform right-shift. The shifters 21′ to 24′ are designed to perform right-shift on the pixel data D₁ to D₄ received from the registers 11₁ to 11₄ in response to the request for performing post filtering. Correspondingly, the shifters 26′ to 29′ are designed to perform right-shift on the pixel data D₆ to D₉ received from the registers 11₆ to 11₉.

The numbers of bit(s) by which the shifters 21′ to 24′, 26′ to 29′ perform right-shift is determined as follows: The shifters 21′ and 29′, positioned on the both ends of the shifter array, are designed to perform 4-bit right shift, and the adjacent shifters 22′, 28′ are designed to perform 3-bit right-shift. Correspondingly, the shifters 23′, 27′ are designed to perform 2-bit right-shift, and the shifters 22′, 26′ are designed to perform 1-bit right-shift. This allows the image processing circuit shown in FIG. 5 to calculate the weighted sum based on different weighting coefficients. Specifically, the image processing circuit in FIG. 5 calculates the weighted sum in accordance with the following equation (4)′:

$${D}_{OUT} ( x , y ) = ( 1 / 16 ) C ( x - 4 , y ) + ( 1 / 8 ) C ( x - 3 , y ) + ( 1 / 4 ) C ( x - 2 , y ) + ( 1 / 2 ) C ( x - 1 , y ) + C ( x , y ) + ( 1 / 2 ) C ( x + 1 , y ) + ( 1 / 4 ) C ( x + 2 , y ) + ( 1 / 8 ) C ( x + 3 , y ) + ( 1 / 16 ) C ( x + 4 , y ) . \qquad {( 4 )}^{′}$$

Those skilled in the art would appreciate that the equation (4)′ is equivalent to the aforementioned equation (4).

1. An image processing circuit comprising:
a plurality of registers retaining pixel data, respectively;
a plurality of absolute difference calculator/adders;
at least one selective multiplier, each disposed between associated one of said registers and associated one of said absolute difference calculator/adders; and
an adder calculating a sum of outputs of said absolute difference calculator/adders,
wherein each of said at least one selective multiplier is designed to perform selected one of first and second operations; said first operation involving transferring pixel data retained in said associated one of said registers as it is to said associated one of said absolute difference calculator/adders, and said second operation outputting a product of a predetermined coefficient and said pixel data retained in said associated one of said registers onto an input of said associated one of said absolute difference calculator/adders, and
wherein each of said absolute difference calculator/adders is designed to perform selected one of absolute difference calculation and adding operation, said absolute difference calculation involving calculating an absolute difference of pixel data inputted thereto, and said adding operation involving calculating a sum of said pixel data inputted thereto.

2. The image processing circuit according to claim 1, wherein, in response to said image processing circuit being placed into a first mode, each of said at least one selective multiplier transfers said pixel data retained in said associated one of said registers as it is to said associated one of said absolute difference calculator/adders, and each of said absolute difference calculator/adders calculates said absolute difference of said pixel data inputted thereto, and
wherein, in response to said image processing circuit being placed into a second mode, each of said at least one selective multiplier outputs said product of said predetermined coefficient and said pixel data retained in said associated one of said registers onto said input of said associated one of said absolute difference calculator/adders, and each of said absolute difference calculator/adders calculates a sum of said pixel data inputted thereto.

3. The image processing circuit according to claim 2, further comprising:
a processing block designed to determine a motion vector from said sum of said outputs of said absolute difference calculator/adders in response to said image processing circuit being placed into said first mode, and to calculated pixel data after post filtering from said sum of said outputs of said absolute difference calculator/adders in response to said image processing circuit being placed into said second mode.

4. The image processing circuit according to claim 2, further comprising:
a resetting circuit designed to reset selected ones of said plurality of registers in response to said image processing circuit being placed into said second mode.

5. The image processing circuit according to claim 1, wherein at least one of said at least one selective multiplier includes a multiplexer designed to output selected one of said pixel data retained in said associated one of said registers and shifted pixel data, said shifted pixel data being obtained through n-bit shift of said pixel data retained in said associated one of said registers.

6. A method of operating image processing circuit comprising:
preparing first pixel data associated with pixels relevant to motion vector search;
providing selected ones of said first pixel data for selective multipliers;
directly providing remaining ones of said first pixel data for associated ones of absolute difference calculator/adders;
transferring said selected ones of said first pixel data to remaining ones of said absolute difference calculator adders through said selective multipliers;
each of said absolute difference calculator/adders calculating an absolute difference of pixel data inputted to a pair of inputs thereof;
calculating a sum of said absolute differences calculated by said absolute difference calculator/adders;
preparing second pixel data associated with a target pixel and neighboring pixels relevant to post filtering;
providing selected ones of said second pixel data for selective multipliers;
directly providing remaining ones of said second pixel data for associated ones of absolute difference calculator/adders;
said selective multipliers providing products of said second pixel data inputted thereto and associated coefficients for inputs of associated ones of said absolute difference calculator/adders;
each of said absolute difference calculator/adders calculating a sum of data inputted to a pair of inputs thereof; and
calculating post-filtered pixel data associated with said target pixel from a sum of outputs of said absolute difference calculator/adders.
